(19) United States
(12) Patent Application Publication
(10) Pub. No.: US 2015/0025844 A1
(43) Pub. Date: Jan. 22, 2015

(54) SURFACE MEASUREMENT APPARATUS AND METHOD

(71) Applicant: Taylor Hobson Limited, Leicester, Leicestershire (GB)

(72) Inventor: Daniel Ian Mansfield, Leicester (GB)

(21) Appl. No.: 14/381,012

(22) PCT Filed: Feb. 27, 2013
(86) PCT No.: PCT/GB2013/050487

§ 371 Date: Aug. 26, 2014

(30) Foreign Application Priority Data
Feb. 27, 2012 (GB) 1203324.7

(51) Int. Cl. G01B 5/20; G01D 18/00; G01B 11/24

(52) U.S. Cl. CPC G01B 5/20; G01B 11/24; G01D 18/00
USPC 702/167; 33/504

(57) ABSTRACT

A metrological apparatus has a workpiece support surface (16) and a mover (9) to carry out a measurement by effecting relative movement in a measurement direction, X, between the workpiece support surface and a stylus (11) such that the stylus is deflected as a stylus tip of the stylus follows surface variations. A transducer (39) provides a measurement data set in a measurement coordinate system representing the deflection, a, of the stylus at measurement points in the measurement direction, X. A rotation device (16) effects relative rotation of the workpiece support surface and the mover about a rotation axis. A data processor is provided to determine a location of intersection of a first measurement data set representing a measurement along a measurement path on a calibration component surface which is not symmetric about the rotation axis and a second measurement data set representing a measurement along a measurement path on the calibration component surface after rotation of 180 degrees about the rotation axis and to determine the frame of reference of the apparatus using the determined intersection.

This invention relates to a surface measurement apparatus and method for facilitating measurement of one or more surface characteristics, in particular surface form.

Surface form or profile measurements may be made by effecting relative movement between a pivotally mounted stylus arm and a workpiece along a traverse path (measurement path) and detecting, using a transducer, the deflection of the stylus arm as a tip of a stylus carried by the stylus arm follows variation in the form of the surface transverse to the traverse path. Accurate measurement requires care in the setting up of the apparatus which can be time consuming.

Measurement of surfaces having significant form, such as aspheric lenses as may be used in optical storage devices such as digital versatile discs (DVD) recorders and players, and moulds for such lenses, present particular challenges because the steepness of the local slope of the surface being measured may result in a higher than desired contact angle between stylus tip and the surface being measured increasing the likelihood of the stylus tip slipping or dragging on the surface which could render the measurement inaccurate and may also damage the stylus. Also the height (depth) to width aspect ratio of the form of the component may make access to the surface difficult, increasing the likelihood of collisions between the stylus arm and the workpiece surface which may, again, detrimentally affect the measurement and damage the stylus.

In order to address the above problems, Taylor Hobson Ltd of Leicester England have produced metrological apparatus sold under the trade name “Talysurf PGI Blu” which enables precision 3-D for measurement of shallow and steep-sided aspheric lenses and moulds and offers 100 nm measurement capability.

This apparatus addresses problems discussed above by enabling the orientation of a traverse unit carrying the stylus to be adjusted so that the stylus arm and the measurement path direction are inclined to the plane of a support surface, such as a turntable, on which the workpiece to be measured is mounted. Allowing the angle of the stylus arm to be adjusted reduces the possibility of the contact angle exceeding a desired limit and also should facilitate access to the surface to be measured. Accuracy of the measurement results is, however, at least partly determined by the accuracy of determination of the coordinate reference frame of the metrological instrument.

Embodiments of the present invention facilitate improvements in the accuracy of the determination of the coordinate reference frame of the metrological instrument, thereby facilitating improvements in accuracy in subsequent measurements.

In one aspect, the present invention provides a metrological apparatus for measuring a surface characteristic of a workpiece, the apparatus comprising:

a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path;
a rotation device to effect relative rotation of the workpiece support surface and the mover about a rotation axis; and
a data processor configured to:
to receive a first measurement data set representing a measurement along a measurement path on a calibration component surface which is not symmetric about the rotation axis;
to receive a second measurement data set representing a measurement along a measurement path on the calibration component surface after rotation of 180 degrees about the rotation axis;
to determine a location of intersection of the first and second measurement data sets; and
to determine the frame of reference of the apparatus on the basis of the determined intersection.

In another aspect, there is provided a method for facilitating measurement of a surface characteristic of a workpiece using an apparatus comprising:

a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path; and
a rotation device to effect relative rotation of the workpiece support surface and the mover about a rotation axis, the method comprising:
determining a location of intersection of a first measurement data set representing a measurement along a measurement path on a calibration component surface which is not symmetric about the rotation axis and a second measurement data set representing a measurement along a measurement path on the calibration component surface after rotation of 180 degrees about the rotation axis; and
determining the frame of reference of the apparatus using the determined intersection.

In another aspect, there is provided a data processor for a metrological apparatus for measuring a surface characteristic of a workpiece, the apparatus comprising:

a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path; and
a rotation device to effect relative rotation of the workpiece support surface and the mover about a rotation axis, the data processor being configured to:
to receive a first measurement data set representing a measurement along a measurement path on a calibration component surface which is not symmetric about the rotation axis;
to receive a second measurement data set representing a measurement along a measurement path on the calibration component surface after rotation of 180 degrees about the rotation axis;
to determine a location of intersection of the first and second measurement data sets; and
to determine the frame of reference of the apparatus on the basis of the determined intersection.

The calibration component surface may be an inclined flank or plane. The measurement direction may be at an angle β to the first axis, x. The stylus may have a pivotal mounting such that an arm of the stylus pivots about a pivot axis as the stylus tip follows surface variations.

In an embodiment, the calibration component surface is an inclined flank or plane, the measurement direction is at an angle β to the first axis, x, a pivotal mounting is provided for the stylus such that an arm of the stylus pivots about a pivot axis as the stylus tip follows surface variations, and wherein a relationship between a location (xₛ, zₛ) of the stylus tip in the frame of reference and in the measurement coordinate system (G, X) is determined in accordance with

L cos(β+α₀)+X cos β−L cos α=xₛ

L sin(β+α₀)+X sin β+ΔZ_{col}−L sin α=zₛ

where α is the stylus deflection angle at a measurement point and is related to the measurement value G;
α₀ is a pivot offset angle.

In an embodiment, a perturbation Δβ is added to the measurement direction angle β, to determine the tangent of the angle of the inclined plane:

$$\frac{d {z}_{s}}{d {x}_{s}} = \pm tan Ψ = \frac{( sin {β}_{o} + {Δβcosβ}_{o} ) + ( \begin{matrix}cos ( {α}_{o} + {β}_{o} - G / L ) - \\ Δβsin ( {α}_{o} + {β}_{o} - G / L )\end{matrix} ) \frac{d G}{d X}}{( cos {β}_{o} - {Δβsinβ}_{o} ) - ( \begin{matrix}Δβcos ( {α}_{o} + {β}_{o} - G / L ) + \\ sin ( {α}_{o} + {β}_{o} - G / L )\end{matrix} ) \frac{d G}{d X}}$$

to solve for Δβ_{±}:

$${Δβ}_{\pm } = \frac{sin ( \pm Ψ - {β}_{o} ) - \frac{d G}{d {X}_{\pm }} cos ( \pm Ψ - {β}_{o} + G / L - {α}_{o} )}{cos ( \pm Ψ - {β}_{o} ) + \frac{d G}{d {X}_{\pm }} sin ( \pm Ψ - {β}_{o} + G / L - {α}_{o} )}$$

and to determine the measurement direction angle as β=β₀+\vec{Δ} β̅ where \vec{Δ} β̅ is the mean of the values of Δβ₋ and Δβ₊.

In an embodiment, the parameters X!, G! and corresponding stylus angle α! representing the location of intersection of the first and second measurement data sets as equal to another parameter set X₂, G₂ and corresponding stylus angle α₂ representing the location of intersection but for which the measurement data value is such that α₂=β+α₀, so that:

xₛ=L cos(β+α₀)+X! cos β−L cos α!=L cos(β+α₀)+X₂ cos β+L cos(α+α₀)

zₛ=L sin(β+α₀)+X! sin β+Z₁−L sin α!=L sin(β+α_{O})+X₂ sin β+Z₂−L sin(β+α₀)

giving (X₂−X!) and (Z₂−Z₁):

(X₂−X!)=L(cos(β+α₀)cos α!)/cos β

(Z₂−Z₁)L(sin(β+α₀)−sin α!)−(X₂−X!)sin β

providing as (X₂−X!) and (Z₂−Z₁) shifts to the measurement direction position and z position to place the stylus tip centre on the rotation axis with the transducer mid-range.

In an embodiment a metrological apparatus has a workpiece support surface and a mover to carry out a measurement by effecting relative movement in a measurement direction, X, between the workpiece support surface and a stylus such that the stylus is deflected as a stylus tip of the stylus follows surface variations. A transducer provides a measurement data set in a measurement coordinate system representing the deflection, α, of the stylus at measurement points in the measurement direction, X. A rotation device effects relative rotation of the workpiece support surface and the mover about a rotation axis. A data processor is provided to determine a location of intersection of a first measurement data set representing a measurement along a measurement path on a calibration component surface which is not symmetric about the rotation axis and a second measurement data set representing a measurement along a measurement path on the calibration component surface after rotation of 180 degrees about the rotation axis and to determine the frame of reference of the apparatus using the determined intersection.

Embodiments of the present invention will now be described, by way of example, with reference to the accompanying drawings, in which:

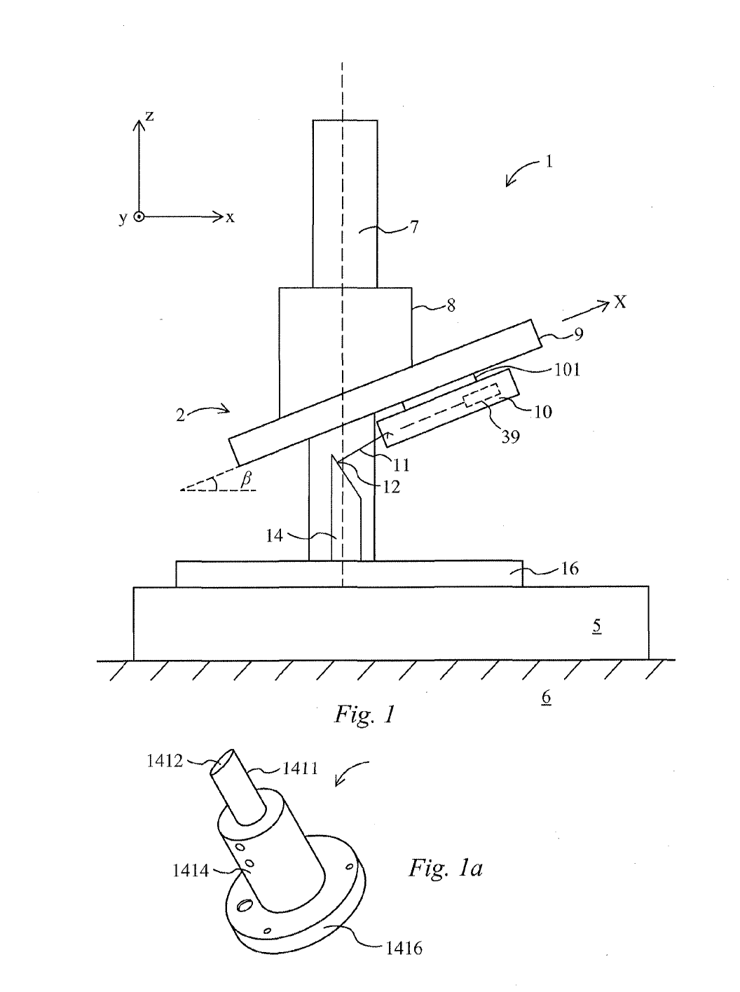

FIG. 1 shows a very schematic representation of a metrological instrument of apparatus embodying the present invention looking in a direction, y, perpendicular to a measurement direction;

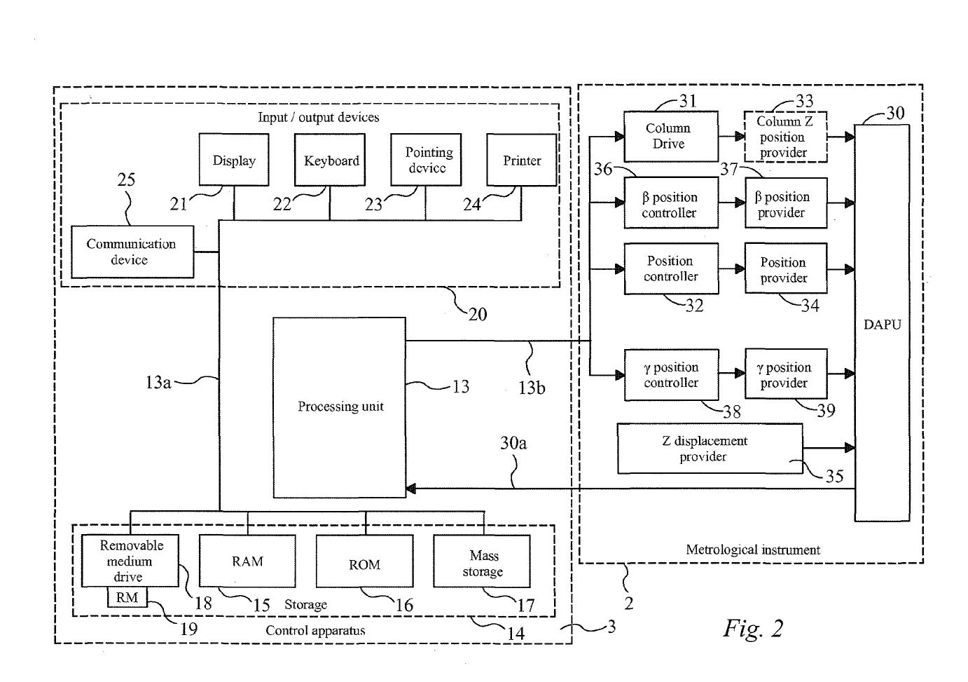

FIG. 2 shows a functional block diagram of data processing and control apparatus of apparatus embodying the present invention;

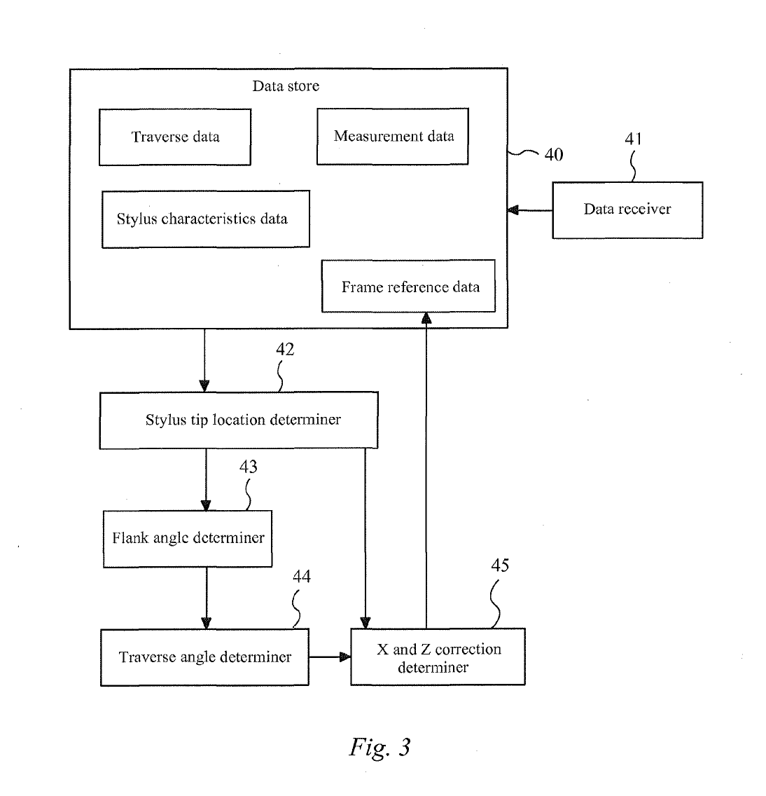

FIG. 3 shows a functional block diagram of setup functionality provided by programming of the control apparatus shown in FIG. 2 for enabling determination of a frame of reference for a metrological instrument;

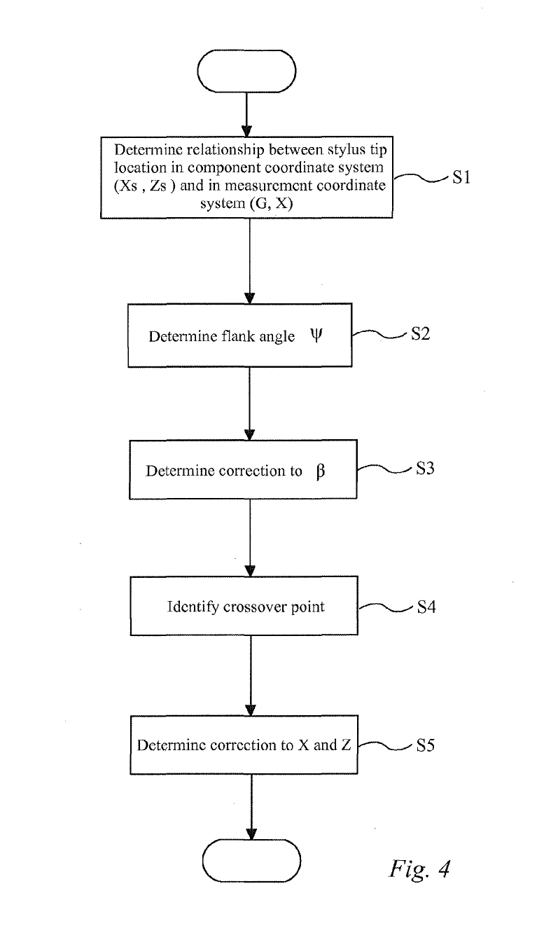

FIG. 4 shows a flow chart illustrating processes carried out by the frame of reference determining functionality shown in FIG. 3; and

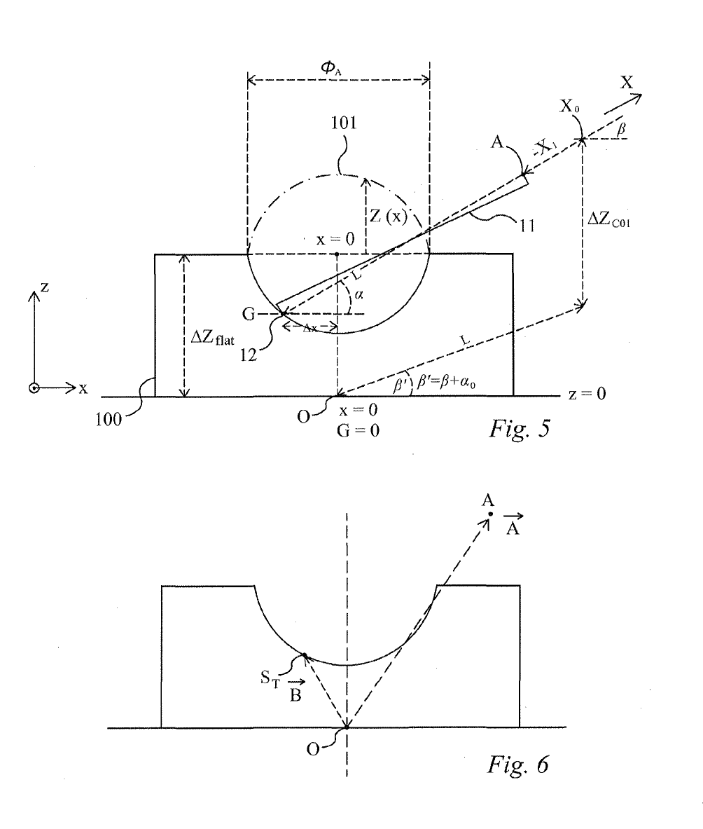

FIGS. 5 to 8 show diagrams for explaining the setup functionality shown in FIGS. 3 and 4.

With reference to the drawings in general, it will be appreciated that the Figures are not to scale and that for example relative dimensions may have been altered in the interest of clarity in the drawings. Also any functional block diagrams are intended simply to show the functionality that exists within the device and should not be taken to imply that each block shown in the functional block diagram is necessarily a discrete or separate entity. The functionality provided by a block may be discrete or may be dispersed throughout the device or throughout a part of the device. In addition, the functionality may incorporate, where appropriate, hard-wired elements, software elements or firmware elements or any combination of these.

Referring now to the drawings, an example metrological apparatus will be described which comprises a metrological instrument and a control apparatus.

FIG. 1 shows a very diagrammatic representation of the metrological instrument 2 of the metrological apparatus 1.

The metrological apparatus 2 has a base 5 that is designed to be supported by a workbench 6. The base 5 carries a column 7 that defines a vertical or z axis reference datum. A column carriage 8 is mounted to the column 7 so as to be movable in the z direction with respect to the column 7. The movement of the column carriage 8 is effected by a motorised drive arrangement (not shown), such as for example a. leadscrew, pulley or other suitable drive arrangement. The base 5 also carries turntable 16 to support a workpiece 14. The turntable 16 has a centring and levelling mechanism (not shown) such as that shown in FIGS. 2 and 3 of GB2,189,604A, the whole contents of which are hereby incorporated by reference.

The column carriage 8 carries a traverse unit 9, which is arranged at an angle β (the transverse angle) to the x-axis (which in the example is represented by the plane of the turntable surface and is generally the horizontal). The transverse unit 9 is movable relative to the column carriage 8 by means of a motorised drive arrangement (not shown) along a straight reference datum (not shown) provided by the traverse unit 9. The direction of this straight reference datum is determined by the orientation of the transverse unit so that the traverse unit 9 is movable in an X direction which extends at the angle β to the x-axis.

The traverse unit 9 carries a measurement probe (or gauge unit) 10 which consists of a pivotally mounted stylus arm (shown very diagrammatically in FIG. 1 in dotted lines within the traverse unit 9) carrying at its free end a stylus arm 11 having a stylus tip 12 which in operation comes into contact with the surface of the workpiece or component under test during a measurement operation so that, as the traverse unit 9 is moved in the measurement direction, the stylus arm 11 pivots to enable the stylus tip 12 to follow surface variations along a measurement path on the surface. Deflection of the stylus arm is detected by a measurement transducer (or displacement provider) 39 shown in dotted lines in FIG. 1. The measurement probe 10 may be mounted to the traverse unit 9 by a y-position adjuster (not shown) so as to be movable in the y-direction with respect to the traverse unit 9. The movement of the measurement probe 10 in the y-direction may be effected by a manual or motorised leadscrew, pulley or other drive arrangement (not shown).

In an example, the traverse unit 9 may be mounted to the column carriage 8 by means of a pivot pin to enable the angle β of the traverse unit 9 with respect to the x-axis to be adjusted. In this particular example, the angle β of the traverse unit 9 is manually adjustable and the traverse unit 9 is held in place at the manually adjusted angle by means of an air brake (not visible in the Figure). As another possibility, the adjustment of the angle β may be automated. As another possibility, the angle β may for some applications be fixed.

FIG. 2 shows a block diagram illustrating functional components of the metrological instrument 2 and the control apparatus 3 of the metrological instrument 1.

Referring now to FIG. 2, the control apparatus 3 is generally a personal computer and has a processing unit 13 coupled via a bus 13a to associated data and program instruction/software storage 14 in the form generally of RAM 15, ROM 16, a mass storage device 17 such as a hard disc drive and at least one removable medium drive 18 for receiving a removable medium (RM) 19, such as a CD-ROM, solid state memory card, DVD, or floppy disc. As another possibility, the removable medium drive may itself be removable, for example it may be an external hard disc drive.

The control apparatus is also coupled via the same or a different bus to input/output devices 20 comprising in this example a display 21, a keyboard 22, a pointing device 23 such as a mouse, a printer 24 and, optionally, a communications device 25 such as at least one of a MODEM and a network card for enabling the control apparatus 3 to communicate signals S via a wired or wireless connection with other control apparatus or computers via a network such as the Internet, an intranet, a WAN or a LAN.

The processing unit 13 is programmed by program instructions and data provided by being at least one of: downloaded as a signal S via the communications device 25; pre-stored in any one or more of ROM 16, RAM 15 and mass storage device 17; read from a removable storage medium 19 received by the removable medium drive 18; and input by the user using the keyboard 22.

The metrological instrument 2 has a data acquisition and processing unit (DAPU) 30 that communicates with the processing unit 13 of the control apparatus 3 via an appropriate link, for example a serial link, 30a to enable data regarding a measurement operation to be communicated to the control apparatus 3.

The control components of the metrological apparatus 2 comprise a column drive controller 31 for driving the carriage 8 up and down the column in the z direction, a measurement direction position controller 32 for driving the measurement probe or gauge unit along the reference datum provided by the traverse unit 9 in the measurement direction X at an angle β to the x-axis and an interferometric z displacement provider 35 for providing a measure of the z displacement of the stylus tip 12 as the stylus arm 11 follows the surface being measured during movement of the traverse unit 9 along a measurement path in a direction at an angle β to the x-axis.

If rotation of the turntable is automated, then the metrological apparatus will also comprise a γ (where γ represents the angle of rotation of the turntable 16 about its spindle axis) position controller 38 for controlling rotation of the turntable 16. Similarly, if the attitude of the traverse unit 9 is adjustable and this adjustment is automated, then a β position controller 36 will be provided for changing the attitude β of the traverse unit 9. γ and β position providers 39, 37 (which may for example be shaft encoders, for example optical shaft encoders, or a linear grating type position provider) are provides to supply signals respectively indicating the angles γ and β to the DAPU 30. Generally the interferometric z displacement provider 35 will be provided within the traverse unit 9.

The measurement direction position controller 32 is associated with a position provider 34 that may be, for example, a shaft encoder associated with a motor providing the position controller 32 or may be a linear grating type of transducer. The column drive 31 may also be associated with a column z position provider 33 (shown in phantom lines in FIG. 4a), for example a shaft encoder associated with a motor providing the column drive 31, or the column z position may be determined in an open loop manner directly from the column motor drive signal. As show in FIG. 2, the column drive 31 and position controller 32 (and other controllers if present) are coupled to the control apparatus 3 (via a link 13b and appropriate interfaces, not shown) for control by instructions from the control apparatus 3. At least some of these instructions may be supplied by the user.

The measurement probe or gauge unit is in this example the measurement probe used in the instruments supplied by Taylor Hobson as the Form Talysurf PGI series and is described in detail in U.S. Pat. No. 5,517,307 (the whole contents of which are hereby incorporated by reference) to which reference should be made for further information. In particular the measurement probe or gauge unit may be based on Taylor Hobson's Form Talysurf PGI 1240 metrological instrument, described in the brochure produced by Taylor Hobson entitled “Form Talysurf PGI 1240, Aspherics Measurement system”. This Form Talysurf PGI series of metrological instruments is particularly suited to measuring the surface form of surfaces having significant form because, as described in U.S. Pat. No. 5,517,307, the interferometric z displacement provider 35 uses a curved diffraction grating that has a radius of curvature which is coincident with the axis about which the stylus arm pivots to provide more accurate z displacement measurements over a longer range.

The processing unit is programmed by program instructions to enable carrying out of measurements further details of examples of such programming may be found in WO2010/943906, the whole contents of which are hereby incorporated by reference.

In the following (see FIGS. 5 to 8):

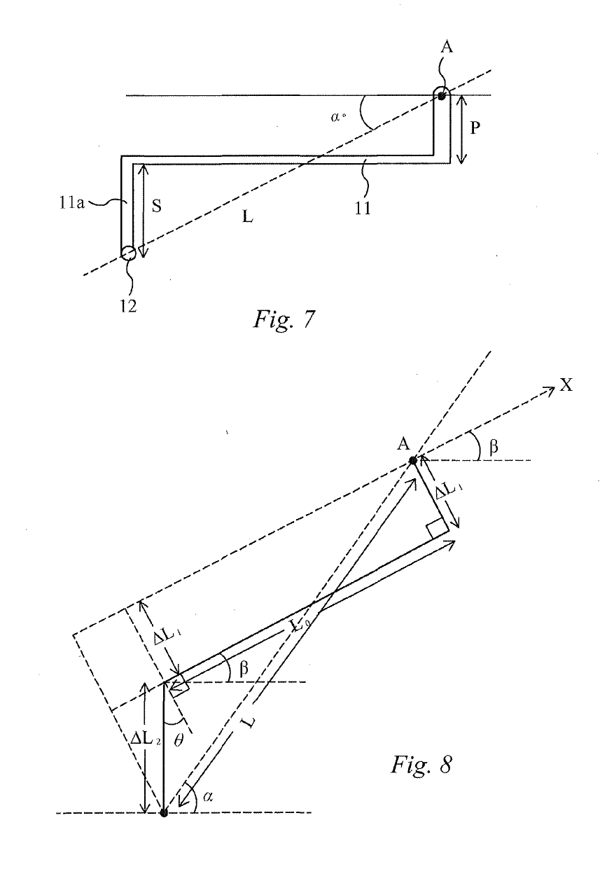

O is the origin, that is the location at which x=0, z=0
Φ_{A} is the nominal base diameter of the workpiece or component whose surface form is to be measured, for example an aspheric lens mould 100 as shown in solid lines in FIG. 5 or an aspheric lens mounted on the attached to a base, the lens being illustrated by the dot-dash line 101 in FIG. 5;
α is the stylus deflection angle between the line passing through the pivot axis A and the centre of the stylus tip 12 and the x axis and represents the degree of deflection of the stylus arm;
G is the gauge reading which as will be explained below is related to the stylus deflection angle α;
β is the angle of the traverse unit to the x axis;
X is the traverse or measurement direction which extends at the angle β to the x axis;
X₁ is the distance the traverse unit has moved in the traverse or measurement direction X from a zero position X₀;
z(x) is the distance in the z direction of a point on the surface being measured from a top surface of the flat part (the body of the mould or the base upon which the aspheric lens is mounted);
Δx is the distance in the x direction of the centre of the stylus tip 12 from x=0 where x=0 corresponds to the turntable spindle axis on which the component to be measured will be centred and aligned, for example as discussed in WO2100/043906, so that a rotational axis of the component (the optical axis in the case of an aspheric lens) is coincident with and aligned to the spindle axis;
ΔZ_{c} or ΔZ_{col} is the distance in the z direction when the stylus tip is at a measurement point on the surface being measured from the corresponding z position at which G=0 (see FIG. 5);
Δz_{flat} is the distance in the z direction from z=0 to the top surface of any flat part, part 100 in FIG. 5;
L₀ is the length of the stylus arm 11;
A is the location of the pivot axis of the stylus arm;
α₀ is the pivot offset angle which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12;
L is the distance between the centre of the stylus tip 12 and the pivot axis A, which distance is determined by the length of the stylus arm L, the pivot offset P and the length S of the stylus shank 11a from the stylus arm to the centre of the stylus tip 12.

In order to facilitate determination of the frame of reference for the measurement instrument, a calibration artefact or calibration component 14 that has a non-rotationally symmetric calibration surface is used. In the example to be described the calibration surface is an inclined plane or flat surface 1412 (“flank”) and the calibration component resembles a lipstick.

The calibration component 14 is shown only diagrammatically in FIG. 1. A more detailed depiction of an example of a calibration component in shown in FIG. 1a. In this example, the artefact 14 has a neck portion 1411 having the plane surface 1412 (“flank”) that is inclined with respect to its base portion 1416 at an angle 6. Artefact 14 also has a collar portion 1414 coupling base portion 1416 to neck portion 1811. As can be seen from FIG. 1a base portion 146 has a number of locating holes for enabling location on the indexing spindle of the turntable.

FIG. 3 shows a functional block diagram illustrating functionality provided by programming of the processing unit to enable determination of the frame of reference for the metrological instrument using the calibration component 14 shown in FIGS. 1 and 1A. FIG. 4 shows a flow chart of processes carried out to determine the frame of reference whilst FIGS. 5 to 8 show drawings of assistance in understanding the processes described below.

As shown in FIG. 3, the reference frame determining functionality includes a data receiver 41 (which may be provided by the input/output devices shown in FIG. 2) to receive data and store the same in a data store 40 which may be provided by, for example, any one or more of the RAM 15, ROM 16 and/or mass storage 17 shown in FIG. 2. As will be explained below, data stored in the data store 40 includes: nominal traverse data; a store for measurement data representing measurements made of the inclined plane or flank of the calibration component; stylus characteristics data including, for example, the length L of the stylus arm 11, a pivot offset angle α₀, the length S of a stylus shank projecting from the stylus arm 11 and carrying at its free end the stylus tip 12. The data store 41 also provides storage for frame reference data determined by the functionality to be described below.

The functionality shown in FIG. 3 includes: a stylus tip location determiner 42 for determining a relationship between a stylus tip location (xₛ, zₛ) in a component coordinate system x, z (where xₛ, zₛ represents the location of a centre of a sphere defined by a contact surface of the stylus tip) and a stylus tip location in a measurement coordinate system (G, X) where G represents the gauge data (that is the data provided by the transducer 39 in the example of FIG. 1) and X₁ represents the position along the traverse direction X; a flank angle determiner 43 for determining a relationship representing the tangent of the angle of the flank or inclined plane of the calibration component by differentiating the x and z stylus tip location relationships and determining their ratio; a traverse angle determiner 44 for determining the traverse angle by solving the relationship representing the tangent of the angle for a perturbation or correction to the traverse angle and adding this to the nominal traverse angle; and a X and z correction determiner 45 for determining shifts required to the traverse and column axes to place the stylus tip centre on the spindle axis at its mid-range range as required to reference the coordinate system, the X and z correction determiner being configured to identify the location at which two (G, X) measurement data sets representing measurements of the flank of the calibration component taken at 180° rotation from one another cross and to set that location equal to the desired mid-gauge reading of G=0.

The processes now to be described with reference to FIG. 4 in order to establish the frame of reference may be carried out using the functionality described with reference to FIG. 3 or any other appropriate functionality.

In order to explain the processes shown in FIG. 4, reference should also be made to FIGS. 5 to 8 which illustrate aspects of the geometry of the metrological instrument.

Referring to FIGS. 5 to 8, the vector from origin O to pivot location A in FIG. 6 is given by:

\vec{A}=(L+X₁)(\hat{i} cos(α₀+β)+\hat{k} sin(α₀+β))+\hat{k}ΔZ_{col} 1)

where î and \hat{k} are the unit vectors in the x and z directions.

(In the example illustrated in FIG. 5 the traverse unit has been driven in the negative X direction from X₀ and so X₁ has a negative value.)

The vector \vec{B} from origin O to the stylus tip centre in FIG. 6 is given by:

\vec{A}−L(\hat{i} cos α+\hat{k} sin α)=îΔx+\hat{k}(ΔZ_{flat}+Z(Δx))≡îΔxₛ+\hat{k}zₛ 2)

The gauge reading G and its relationship with the stylus deflection angle α are given by:

G=L(α₀+β−α) [symbol] α=α₀+β−(G/L) 3)

Extracting the orthogonal components (x,z) from equations 1 and 2 allows a pair of relationships to be defined that relate the stylus tip centre values (xₛ,zₛ) in terms of the stylus and instrument parameters as follows:

L cos(β+α₀)+X cos β−L cos α=xₛ

L sin(β+α₀)+X sin β+ΔZ_{col}−L sin α=zₛ 4)

FIGS. 7 and 8 in particular show the geometry and dimensions of the stylus. This data is either pre-stored or input by the operator. Where a number of different styli are available, the operator may select the stylus characteristics data form a number of pre-stored sets of stylus characteristics data. As another possibility, the stylus itself may carry the data in a local non-volatile memory or may carry identification data identifying the stylus so that the control apparatus can select the correct set of stylus data from its data store. In this example, the stylus data includes the length L₀ is of the stylus arm 11, the pivot offset angle α₀ which as shown in FIG. 7 is an angle between a line parallel to the x axis passing through the pivot axis A and a line passing through the pivot axis A and the centre of the stylus tip 12 with the stylus arm parallel to the traverse axis and is determined, as illustrated in FIG. 7, by the offset P of the pivot axis A from the stylus arm, the length of the stylus arm L and the length S of the stylus shank 11a from the stylus arm to the centre of the stylus tip 12, and the length S of the stylus shank 11a from the stylus arm to the centre of the stylus tip 12.

The traverse angle β will generally be input by the operator but could be determined by detecting the degree of rotation using an appropriate transducer. The measurement step Xᵢ may be pre-defined but could be operator-selectable.

The stylus characteristics data also includes the geometry and dimensions of the stylus tip. In this example, the stylus tip is in the form of a sphere of given radius r. The centre of that sphere will not coincide with the point on the stylus tip that contacts the surface being measured. If the nominal form of the component to be measured is represented as z(x) then it has a gradient of

$$\frac{d z}{d x} = tan Ψ .$$

For a stylus tip of radius r traversing this surface, the tip centre is then defined by

zₛ=z+r cos Ψ

xₛ=x−r sin Ψ 5)

where the point of contact between the stylus tip and the surface is (x, z) and the spindle axis defines the z-axis. These stylus tip centre values (xₛ, zₛ) are used throughout the following.

In order to determine the frame of reference, measurement data sets representing measurements of the flank of the calibration component taken 180° apart are taken. Accordingly, as a first step, the calibration component is placed by the operator on the indexing spindle of the turntable 16, centred and leveled, and then two measurements of the inclined plane surface 1412 are made with the turntable rotated by 180 degrees between measurements. In this example measurements of the inclined plane (flank) 1412 are made at spindle angles of 0° and 180°, corresponding to lipstick flank angles ±tan Θ. These two measurement data sets are then stored.

The two measurements of the flank of the calibration component taken 180 degrees apart (in this example at spindle angles of 0° and 180°, corresponding to lipstick flank angles ±tan Θ) generate two pairs of (X,G) measurement data-sets. The traverse axis X (which extends at an angle β to the spindle axis normal) has, when calibrated, a value of zero if the stylus tip centre is located on the spindle axis with the gauge at mid-range.

As will be explained below, these two measurement data-sets can initially be used to provide a more accurate value of β which can then be used to provide a more accurate coordinate origin.

As shown in FIG. 4, at S1 the relationship between the stylus tip location in the component coordinate system (xₛ, zₛ) and in the measurement coordinate system (G, X) is determined in accordance with equations 4) reproduced below:

L cos(β+α₀)+X cos β−L cos α=xₛ

L sin(β+α₀)+X sin β+ΔZ_{col}−L sin α=zₛ 4

At S2, the tangent of the flank angle is determined by first taking the differential of each of the pair of equations 4).

A perturbation to the traverse angle is also defined such that:

β=β₀+Δβ 5)

This provides:

dxₛ=dX cos β+L sin αdα=dX cos β−sin αdG=dX(cos β₀−Δβ sin β)−sin αdG

dzₛ=dX sin β−L cos αdα=dX sin β+cos αdG=dX(sin β₀+Δβ cos β₀)+cos αdG 6)

or

dxₛ=dX(cos β₀−sin β₀)−(Δβ cos(α₀+β₀−G/L)+sin(α₀+β₀−G/L))dG

dzₛ=dX(sin β₀+Δβ cos β₀)+(cos(α₀+β₀−G/L)−Δβ sin(α₀+β₀G/L))dG 7)

The ratio between the two differentials is determined to determine the tangent of the flank angle tan Ψ:

$$\frac{d {z}_{s}}{d {x}_{s}} = \pm tan Ψ = \frac{( sin {β}_{o} + {Δβcosβ}_{o} ) + ( \begin{matrix}cos ( {α}_{o} + {β}_{o} - G / L ) - \\ Δβsin ( {α}_{o} + {β}_{o} - G / L )\end{matrix} ) \frac{d G}{d X}}{( cos {β}_{o} - {Δβsinβ}_{o} ) - ( \begin{matrix}Δβcos ( {α}_{o} + {β}_{o} - G / L ) + \\ sin ( {α}_{o} + {β}_{o} - G / L )\end{matrix} ) \frac{d G}{d X}} \qquad 8 )$$

Then at S3 solving for Δβ gives:

$${Δβ}_{\pm } = \frac{sin ( \pm Ψ - {β}_{o} ) - \frac{d G}{d {X}_{\pm }} cos ( \pm Ψ - {β}_{o} + G / L - {α}_{o} )}{cos ( \pm Ψ - {β}_{o} ) + \frac{d G}{d {X}_{\pm }} sin ( \pm Ψ - {β}_{o} + G / L - {α}_{o} )} \qquad 9 )$$

The angle of the traverse axis is determined at S3 as β=β₀+\vec{Δ} β̅ \vec{Δ} β̅ where OR is the mean of the entire sets of Δβ₋ and Δβ₊ values specified by the (G, X) data in equation 9).

At S4 the location at which the two (X, G) data-sets cross is determined. For convenience, this cross point is designated below as (X!, G!) with a corresponding value of αdesignated α!. This stylus location also corresponds to another parameter set X₂, G₂ in which G₂ is a mid-gauge reading of zero implying that α₂=β+α₀. This gives:

xₛ=L cos(β+α₀)+X! cos β−L cos α!=L cos(β+α₀)+X₂ cos β−L cos(β+α₀)

zₛ=L sin(β+α₀)+X! sin β+Z₁−L sin α!=L sin(β+α₀)+X₂ sin β+Z₂−L sin(β+α₀) 10)

This expression yields the required shifts to the traverse X and column z (sometimes Z herein) axes to place the stylus tip centre on the spindle axis at its mid-gauge location as required to reference the co-ordinate system as being:

(X₂−X!)=L(cos(β+α₀)−cos α!)/cos β

(Z₂−Z₁)=L(sin(β+α₀)sin α!)−(X₂−X!)sin β 11)

A more accurate frame of reference for the metrological instrument is thus determined facilitating increased accuracy in subsequent measurements.

The above procedure may be repeated for the y axis by rotating the turntable through 90 degrees and then taking measurements of the flank of the calibration component at that angle of rotation and then at 270 degrees (that is 180 degrees from the first measurement) and repeating the process discussed above with reference to FIGS. 3 and 4 for the y axis.

Subsequent measurements may be carried out in known manner, for example as discussed in WO 2010/043906, the whole contents of which are hereby incorporated by reference.

### MODIFICATIONS AND VARIATIONS

A person skilled in the art will appreciate that a number of different methods of centring and levelling could be employed with the above-described techniques. For example, as one possibility, mechanical centring is used. It may be possible to use software centring and/or levelling, for example as described in U.S. Pat. No. 5,926,781, the whole contents of which are hereby incorporated by reference, which may enable omission of at least some of the centring and levelling mechanisms discussed herein.

Other forms of centring and levelling mechanism may be used. For example, it may be possible to use wedge assemblies of the type described in the Applicant's International Application Publication No. WO2007/091087, the whole contents of which are hereby incorporated by reference. Other levelling mechanism that do not use wedge assemblies may be used, for example, as discussed in U.S. Pat. No. 4,731,934, the whole contents of which are hereby incorporated by reference.

In the above example, the stylus tip is in the form of a sphere of given radius r but it could have another form, for example a frusto-conical form with a part-spherical contact surface.

It will be appreciated that the traverse angle β could be zero. Also, the stylus need not necessarily be a contact stylus but could be any form of stylus that follows the frame of a surface, although this may require modification of the definition of the stylus tip centre.

Also, other gauge units or transducer units than the ones described above may be used, for example it may be possible to use an LVDT gauge or a different form of optical interferometric gauge.

A person skilled in the art will appreciate that the methods and apparatus described herein need not be limited in their application to instruments for the measurement of aspheric, concave or convex surfaces, and may equally be applied to instruments for the measurement of other surfaces.

It may be possible to use other forms of asymmetric surface other than a simple inclined plane as the calibration component, although this may increase the complexity of the calculations.

As one possibility, there is provided a computer program, computer program product, or computer readable medium, comprising computer program instructions to cause a programmable computer to carry out any one or more of the methods described herein.

Various features described above may have advantages with or without other features described above.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A metrological apparatus for measuring a surface characteristic of a workpiece, the apparatus comprising:
a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path;
a rotation device to effect relative rotation of the workpiece support surface and the mover about a rotation axis; and
a data processor configured to:
to receive a first measurement data set representing a measurement along a measurement path on a calibration component surface which is not symmetric about the rotation axis;
to receive a second measurement data set representing a measurement along a measurement path on the calibration component surface after rotation of 180 degrees about the rotation axis;
to determine a location of intersection of the first and second measurement data sets; and
to determine the frame of reference of the apparatus on the basis of the determined intersection.

2. A metrological apparatus according to claim 1, wherein the calibration component surface is an inclined flank or plane.

3. A metrological apparatus according to any of the preceding claims, wherein the measurement direction is at an angle β to the first axis, x.

4. A metrological apparatus according to any of the preceding claims, providing a pivotal mounting for the stylus such that an arm of the stylus pivots about a pivot axis as the stylus tip follows surface variations.

5. A metrological apparatus according to claim 1, wherein the calibration component surface is an inclined flank or plane, the measurement direction is at an angle β to the first axis, x, a pivotal mounting is provided for the stylus such that an arm of the stylus pivots about a pivot axis as the stylus tip follows surface variations, and wherein a relationship between a location (xₛ, zₛ) of the stylus tip in the frame of reference and in the measurement coordinate system (G, X) is determined in accordance with
L cos(β+α₀)+X cos β−L cos α=xₛ
L sin(β+α₀)+X sin β+ΔZ_{col}−L sin α=zₛ
where α is the stylus deflection angle at a measurement point and is related to the measurement value G;
α₀ is a pivot offset angle.

6. A metrological apparatus according to claim 5, wherein the data processor is configured to determine the tangent of the angle of the inclined plane as dzₛ/dxₛ, to define a perturbation Δβ of the measurement direction angle β, to solve dzₛ/dxₛ for Δβ and ₜₒ modify the measurement direction angle in accordance with the determined perturbation Δβ.

7. A metrological apparatus according to claim 5, wherein the data processor is configured to add a perturbation Δβ to the measurement direction angle β, to determine the tangent of the angle of the inclined plane:
$$\frac{d {z}_{s}}{d {x}_{s}} = \pm tan Ψ = \frac{( sin {β}_{o} + {Δβcosβ}_{o} ) + ( \begin{matrix}cos ( {α}_{o} + {β}_{o} - G / L ) - \\ Δβsin ( {α}_{o} + {β}_{o} - G / L )\end{matrix} ) \frac{d G}{d X}}{( cos {β}_{o} - {Δβsinβ}_{o} ) - ( \begin{matrix}Δβcos ( {α}_{o} + {β}_{o} - G / L ) + \\ sin ( {α}_{o} + {β}_{o} - G / L )\end{matrix} ) \frac{d G}{d X}}$$
to solve for Δβ_{±}:
$${Δβ}_{\pm } = \frac{sin ( \pm Ψ - {β}_{o} ) - \frac{d G}{d {X}_{\pm }} cos ( \pm Ψ - {β}_{o} + G / L - {α}_{o} )}{cos ( \pm Ψ - {β}_{o} ) + \frac{d G}{d {X}_{\pm }} sin ( \pm Ψ - {β}_{o} + G / L - {α}_{o} )}$$
and to determine the measurement direction angle as β=β₀+\vec{Δ} β̅ where \vec{Δ} β̅ is the mean of the values of Δβ₋ and Δβ₊.

8. A metrological apparatus according to claim 5, 6 or 7, wherein the data processor is configured to set the parameters X!, G! and corresponding stylus angle α! representing the location of intersection of the first and second measurement data sets as equal to another parameter set X₂, G₂ and corresponding stylus angle α₂ representing the location of intersection but for which the measurement data value is such that α₂=β+α₀, so that:
xₛ=L cos(β+α₀)+X! cos β−L cos α!=L cos(β+α₀)+X₂ cos β−L cos(β+α₀)
zₛ=L sin(β+α₀)+X! sin β+Z₁−L sin α!=L sin(β+α₀)+X₂ sin β+Z₂−L sin(β+α₀)
and to solve for (X₂−X!) and (Z₂−Z₁):
(X₂−X!)=L(cos(β+α₀)−cos α!)/cos β
(Z₂−Z₁)=L(sin(β+α₀)−sin α!)−(X₂−X!)sin β
to provide as (X₂−X!) and (Z₂−Z₁) shifts to the measurement direction position and z position to place the stylus tip centre on the rotation axis with the transducer mid-range.

9. A metrological apparatus according to any of the preceding claims, comprising a traverse unit to move the stylus in the measurement direction.

10. A metrological apparatus according to claim 9, wherein the traverse unit is movable in the z direction.

11. A metrological apparatus according to any of the preceding claims, wherein the surface characteristic is a surface form of a surface of the workpiece.

12. A metrological apparatus according to any of the preceding claims, wherein the rotation device is a turntable which also provides the workpiece support surface.

13. A method for facilitating measurement of a surface characteristic of a workpiece using an apparatus comprising:
a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path; and
a rotation device to effect relative rotation of the workpiece support surface and the mover about a rotation axis, the method comprising:
determining a location of intersection of a first measurement data set representing a measurement along a measurement path on a calibration component surface which is not symmetric about the rotation axis and a second measurement data set representing a measurement along a measurement path on the calibration component surface after rotation of 180 degrees about the rotation axis; and
determining the frame of reference of the apparatus using the determined intersection.

14. A method according to claim 13, wherein the calibration component surface is an inclined flank or plane.

15. A method according to claim 13 or 14, wherein the measurement direction is at an angle β to the first axis, x.

16. A method according to claim 13, 14 or 15, providing a pivotal mounting for the stylus such that an arm of the stylus pivots about a pivot axis as the stylus tip follows surface variations.

17. A method according to claim 13, wherein the calibration component surface is an inclined flank or plane, the measurement direction is at an angle β to the first axis, x, a pivotal mounting is provided for the stylus such that an arm of the stylus pivots about a pivot axis as the stylus tip follows surface variations, and wherein a relationship between a location (xₛ, zₛ) of the stylus tip in the frame of reference and in the measurement coordinate system (G, X) is determined in accordance with
L cos(β+α₀)+X cos β−L cos α=xₛ
L sin(β+α₀)+X sin β+ΔZ_{col}−L sin α=zₛ
where α is the stylus deflection angle at a measurement point and is related to the measurement value G;
α₀ is a pivot offset angle.

18. A method according to claim 17, comprising determining the tangent of the angle of the inclined plane as dzₛ/dxₛ, defining a perturbation Δβ of the measurement direction angle β, to solve dzₛ/dxₛ for Δβ and _{modifying} the measurement direction angle in accordance with the determined perturbation Δβ.

19. A method according to claim 17, comprising adding a perturbation Δβ to the measurement direction angle β, determining the tangent of the angle of the inclined plane:
$$\frac{d {z}_{s}}{d {x}_{s}} = \pm tan Ψ = \frac{( sin {β}_{o} + {Δβcosβ}_{o} ) + ( \begin{matrix}cos ( {α}_{o} + {β}_{o} - G / L ) - \\ Δβsin ( {α}_{o} + {β}_{o} - G / L )\end{matrix} ) \frac{d G}{d X}}{( cos {β}_{o} - {Δβsinβ}_{o} ) - ( \begin{matrix}Δβcos ( {α}_{o} + {β}_{o} - G / L ) + \\ sin ( {α}_{o} + {β}_{o} - G / L )\end{matrix} ) \frac{d G}{d X}}$$
to solve for Δβ_{±}:
$${Δβ}_{\pm } = \frac{sin ( \pm Ψ - {β}_{o} ) - \frac{d G}{d {X}_{\pm }} cos ( \pm Ψ - {β}_{o} + G / L - {α}_{o} )}{cos ( \pm Ψ - {β}_{o} ) + \frac{d G}{d {X}_{\pm }} sin ( \pm Ψ - {β}_{o} + G / L - {α}_{o} )}$$
and determining the measurement direction angle as β=β₀+\vec{Δ} β̅ where \vec{Δ} β̅ is the mean of the values of Δβ₋ and Δβ₊.

20. A method according to claim 17, 18 or 19, comprising setting the parameters X!, G! and corresponding stylus angle α! representing the location of intersection of the first and second measurement data sets as equal to another parameter set X₂, G₂ and corresponding stylus angle α₂ representing the location of intersection but for which the measurement data value is such that α₂=β+α₀, so that:
xₛ=L cos(β+α₀)+X! cos β−L cos α!=L cos(β+α₀)+X₂ cos β−L cos(β+α₀)
zₛ=L sin(β+α₀)+X! sin β+Z₁−L sin α!=L sin(β+α₀)+X₂ sin β+Z₂−L sin(β+α₀)
and solving for (X₂−X!) and (Z₂−Z₁):
(X₂−X!)L(cos(β+α₀)−cos α!)/cos β
(Z₂−Z₁)=L(sin(β+α₀)−sin α!)−(X₂−X!)sin β
to provide as (X₂−X!) and (Z₂−Z₁) shifts to the measurement direction position and z position to place the stylus tip centre on the rotation axis with the transducer mid-range.

21. A method according to any of claims 13 to 20, wherein a traverse unit moves the stylus in the measurement direction.

22. A method according to claim 21, wherein the traverse unit is movable in the z direction.

23. A method according to any of claims 13 to 22, wherein the surface characteristic is a surface form of a surface of the workpiece.

24. A method according to any of claims 13 to 23, wherein the rotation device is a turntable which also provides the workpiece support surface.

25. A data processor for a metrological apparatus for measuring a surface characteristic of a workpiece, the apparatus comprising:
a workpiece support surface defining a frame of reference having a first axis, x, extending parallel to the workpiece support surface and a second axis, z, normal to the workpiece support surface;
a mover to carry out a measurement by effecting relative movement in a measurement direction, X, between the workpiece support surface and a stylus such that the stylus is deflected as a stylus tip of the stylus follows surface variations along a measurement path on a surface of a workpiece supported on the workpiece support surface;
a transducer to provide a measurement data set in a measurement coordinate system representing the deflection, a, of the stylus at measurement points in the measurement direction, X, along the measurement path; and
a rotation device to effect relative rotation of the workpiece support surface and the mover about a rotation axis, the data processor being configured to:
to receive a first measurement data set representing a measurement along a measurement path on a calibration component surface which is not symmetric about the rotation axis;
to receive a second measurement data set representing a measurement along a measurement path on the calibration component surface after rotation of 180 degrees about the rotation axis;
to determine a location of intersection of the first and second measurement data sets; and
to determine the frame of reference of the apparatus on the basis of the determined intersection.

26. A data processor according to claim 25, wherein the calibration component surface is an inclined flank or plane.

27. A data processor according to claim 25 or 26, wherein the measurement direction is at an angle β to the first axis, x.

28. A data processor according to any of claims 25 to 27, providing a pivotal mounting for the stylus such that an arm of the stylus pivots about a pivot axis as the stylus tip follows surface variations.

29. A data processor according to claim 25, wherein the calibration component surface is an inclined flank or plane, the measurement direction is at an angle β to the first axis, x, a pivotal mounting is provided for the stylus such that an arm of the stylus pivots about a pivot axis as the stylus tip follows surface variations, and wherein a relationship between a location (xₛ, zₛ) of the stylus tip in the frame of reference and in the measurement coordinate system (G, X) is determined in accordance with
L cos(β+α₀)+X cos β−L cos α=xₛ
L sin(β+α₀)+X sin β+ΔZ_{col}−L sin α=zₛ
where α is the stylus deflection angle at a measurement point and is related to the measurement value G;
α₀ is a pivot offset angle.

30. A data processor according to claim 29, wherein the data processor is configured to determine the tangent of the angle of the inclined plane as dzₛ/dxₛ, to define a perturbation Δβ of the measurement direction angle β, to solve dzₛ/dxₛ for Δβ and ₜₒ modify the measurement direction angle in accordance with the determined perturbation Δβ.

31. A data processor according to claim 29, wherein the data processor is configured to add a perturbation Δβ to the measurement direction angle β, to determine the tangent of the angle of the inclined plane:
$$\frac{d {z}_{s}}{d {x}_{s}} = \pm tan Ψ = \frac{( sin {β}_{o} + {Δβcosβ}_{o} ) + ( \begin{matrix}cos ( {α}_{o} + {β}_{o} - G / L ) - \\ Δβsin ( {α}_{o} + {β}_{o} - G / L )\end{matrix} ) \frac{d G}{d X}}{( cos {β}_{o} - {Δβsinβ}_{o} ) - ( \begin{matrix}Δβcos ( {α}_{o} + {β}_{o} - G / L ) + \\ sin ( {α}_{o} + {β}_{o} - G / L )\end{matrix} ) \frac{d G}{d X}}$$
to solve for Δβ_{±}:
$${Δβ}_{\pm } = \frac{sin ( \pm Ψ - {β}_{o} ) - \frac{d G}{d {X}_{\pm }} cos ( \pm Ψ - {β}_{o} + G / L - {α}_{o} )}{cos ( \pm Ψ - {β}_{o} ) + \frac{d G}{d {X}_{\pm }} sin ( \pm Ψ - {β}_{o} + G / L - {α}_{o} )}$$
and to determine the measurement direction angle as β=β₀+\vec{Δ} β̅ where \vec{Δ} β̅ is the mean of the values of Δβ₋ and Δβ₊.

32. A data processor according to claim 29, 30 or 31, wherein the data processor is configured to set the parameters X!, G! and corresponding stylus angle α! representing the location of intersection of the first and second measurement data sets as equal to another parameter set X₂, G₂ and corresponding stylus angle α₂ representing the location of intersection but for which the measurement data value is such that α₂=β+α₀, so that:
xₛ=L cos(β+α₀)+X! cos β−L cos α!=L cos(β+α₀)+X₂ cos β−L cos(β+α₀)
zₛ=L sin(β+α₀)+X! sin β+Z₁−L sin α!=L sin(β+α₀)+X₂ sin β+Z₂−L sin(β+α₀)
and to solve for (X₂−X!) and (Z₂−Z₁):
(X₂−X!)=L(cos(β+α₀)−cos α!)/cos β
(Z₂−Z₁)=L(sin(β+α₀)−sin α!)−(X₂−X!)sin β
to provide as (X₂−X!) and (Z₂−Z₁) shifts to the measurement direction position and z position to place the stylus tip centre on the rotation axis with the transducer mid-range.

33. A metrological apparatus substantially as hereinbefore described with reference to and/or as illustrated in the accompanying drawings.

34. A data processor substantially as hereinbefore described with reference to and/or as illustrated in the accompanying drawings.

35. A method substantially as hereinbefore described with reference to and/or as illustrated in FIG. 4 of the accompanying drawings.

36. A computer program product comprising program instructions to program a processor to carry out data processing of a method according to any of claims 13 to 24 and 35 or to program a processor to provide the data processor of any of claims 1 to 12 and 25 to 34.
